(19) United States
(12) Patent Application Publication
(10) Pub. No.: US 2017/0031986 A1
(43) Pub. Date: Feb. 2, 2017

(54) Method and System for Providing Integrated Virtualized Database Management and Software Defined Network Topology

(71) Applicants: Xu LI, Nepean (CA); Jaya RAO, Ottawa (CA); Sophie VRZIC, Kanata (CA)

(72) Inventors: Xu LI, Nepean (CA); Jaya RAO, Ottawa (CA); Sophie VRZIC, Kanata (CA)

(73) Assignee: Huawei Technologies Co., Ltd., Shenzhen (CN)

(21) Appl. No.: 14/814,581

(22) Filed: Jul. 31, 2015

(51) Int. Cl. G06F 17/30

(52) U.S. Cl. CPC G06F 17/30463; G06F 17/30566

(57) ABSTRACT

A communication network providing database functionality and associated method are provided. The network implements Software Defined Networking and Network Function Virtualization. In response to a database query, the network instantiates a set of database functions as Virtual Functions of the communication network. The Virtual Functions correspond to a query execution plan, which can be generated by elements in the network. The query execution plan may instantiate virtual functions of the network in an efficient manner to draw from database tables distributed through the network and process same in order to execute the query. This may include instantiating new processing nodes at desired locations for performing database operations.

### CROSS-REFERENCE TO RELATED APPLICATIONS

This is the first application filed for the present invention.

### FIELD OF THE INVENTION

The present invention pertains to the fields of database management, software defined networking, and network function virtualization, and in particular to a method and system for providing integrated virtualized database management within a network supporting features such as software defined networking and/or network function virtualization.

### BACKGROUND

Database virtualization allows for database resources such as computation and storage resources to be allocated dynamically on demand. For example, virtual databases may include data that is stored remotely in potentially heterogeneous and semi-structured sources, or in a plurality of separate databases. Database management systems in general enable the storage, modification and extraction of information from a database. Query optimization in databases allows for the efficient execution of queries in a given database.

As a separate matter, Software Defined Networking (SDN) has been proposed to allow for the management of network services through abstraction of lower-level functionality. Control functions may be separated from forwarding functions for example by controlling the forwarding nodes from a control element. Network Function Virtualization (NFV) has been proposed to facilitate the virtualization of entire classes of network node functions. Virtual Network Functions (VNF) can comprise or operate on one or more virtual machines running on relatively generic servers or computing equipment, such as commercial-off-the-shelf hardware capable of being configured to provide a variety of functionalities, as opposed to dedicated hardware for a given functionality.

However, current SDN and NFV designs do not sufficiently support efficient database management system operations, such as query execution. Therefore there is a need for a method and system for providing virtualized database management integrated with and software defined networking and/or network function virtualization, that is not subject to one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide a method and system for providing virtualized database management integrated with software defined networking and/or network function virtualization. In accordance with embodiments of the present invention, there is provided a communication apparatus comprising: a Software Defined Topology (SDT) module configured to define a set of virtual functions and logical connections therebetween for instantiation using hardware resource components of a communication network; the SDT module further configured to define a set of database functions belonging to the set of virtual functions in accordance with a query execution plan after the SDT is invoked in response to a database query.

In accordance with embodiments of the present invention, there is provided a communication network comprising: a Software Defined Topology (SDT) module configured to define a set of Virtual Functions and logical connections therebetween for instantiation using hardware resource components of the communication network; a query response module of a Database Management System (DBMS) configured to receive a database query and to invoke the SDT module to generate in association with nodes of the communication network and in accordance with a query execution plan, a set of database functions belonging to the set of Virtual Functions.

In accordance with embodiments of the present invention, there is provided a method for providing database functionality in a communication network, the method comprising: in response to a database query, determining a query execution plan comprising an indication of a set of Virtual Functions and a set of hardware resource components of the communication network for use in implementing the set of Virtual Functions; instantiating the set of Virtual Functions and logical connections therebetween using the indicated set of hardware resource components; and executing the query according to the query execution plan.

### BRIEF DESCRIPTION OF THE FIGURES

Further features and advantages of the present invention will become apparent from the following detailed description, taken in combination with the appended drawings, in which:

FIG. 1 illustrates a method for providing database functionality in a communication network, in accordance with embodiments of the present invention.

FIG. 2A illustrates a communication network provided in accordance with embodiments of the present invention.

FIG. 2B illustrates another aspect of a communication network provided in accordance with embodiments of the present invention.

FIG. 3 illustrates a Network Function Virtualization framework in accordance with the prior art.

FIG. 4A illustrates a query situation in accordance with an example embodiment of the present invention.

FIG. 4B illustrates a query execution plan for the query situation of FIG. 4A, in accordance with an embodiment of the present invention.

FIG. 4C illustrates a query execution plan for the query situation of FIG. 4A, in accordance with another embodiment of the present invention.

FIG. 4D illustrates a query execution plan for the query situation of FIG. 4A, in accordance with another embodiment of the present invention.

FIG. 5 illustrates a network configuration corresponding to generation of a query execution plan, in accordance with an embodiment of the present invention.

FIG. 6 illustrates operation of an embodiment of the present invention relative to a network architecture.

### DETAILED DESCRIPTION

### Definitions

As used herein, the term “about” should be read as including variation from the nominal value, for example, a +/−10% variation from the nominal value. It is to be understood that such a variation is always included in a given value provided herein, whether or not it is specifically referred to.

The term “Virtual Network Function” corresponds to a function enabling operation of a communication network, such as routing, switching, gateways, firewalls, load balancers, servers, mobility management entities, and the like. The function is virtualized in the sense that it may utilize a set of virtual resources, such as computing, storage and networking resources, rather than utilizing hardware resources directly or dedicated hardware resources. As such, Virtual Network Functions may be instantiated on an as-needed basis using available virtual resources.

The term “Virtual Application Function” corresponds to a function enabling operation of an application running on a network.

The term “Virtual Function” corresponds to a Virtual Network Function, a Virtual Application function, or a combination of Virtual Network Functions and/or Virtual Application Functions.

The term “Software Defined Topology” (SDT) corresponds to a technology by which service-specific network logical topologies may be defined. SDT may be used to define Virtual Function Point of Presence (PoP) and the logical connections between Virtual Functions. SDT may also be used to define logical connections between Virtual Function PoPs and corresponding service traffic sources and/or service traffic destinations.

The term “optimization” corresponds to an operation that determines or attempts to determine a course of action having at least a desired performance and/or at least approximately satisfying a set of constraints. For example, optimizations may attempt determine values for a set of decision variables that lead to maximization or minimization of an objective function, while also satisfying the set of constraints, as would be readily understood by a worker skilled in the art. Although it may be desirable to determine a solution that achieves the global maximum (or minimum) of the objective function over the set of feasible solutions, defined by the constraints, optimization as used herein may in some cases return a solution that achieves somewhat less than the global maximum (or somewhat larger than the global minimum).

Unless defined otherwise, all technical and scientific terms used herein have the same meaning as commonly understood by one of ordinary skill in the art to which this invention belongs.

Embodiments of the present invention comprise implementing a Virtualized Database Management System (V-DBMS), for example by providing the V-DBMS as a service, in a Software-Defined Topology (SDT)-capable network. The V-DBMS may generate query execution plans in response to database queries, and such generation may include query optimization. The query execution plan may include a plan for configuration of a query-specific network logical topology, for example including a plan for instantiation of Virtual Functions (VF) such as Virtual Network Functions (VNF) and/or Virtual Application Functions (VAF), along with the interconnection between VFs where applicable. As such, embodiments of the present invention may provide for a cross-layer solution for implementation of a V-DBMS within a SDT-capable network, that is involving cooperation across the application and network layers.

In various embodiments, the Database Management System (DBMS) supports a virtualized database. In various embodiments, the DBMS supports a distributed database. In various embodiments, the DBMS supports a database that is both virtualized and distributed.

The query-specific network logical topology may correspond to a logical topology of a network which is instantiated for generating a response to a query in accordance with a query execution plan, and which may be temporary, for example being instantiated for execution of the query and subsequently de-instantiated.

Embodiments of the present invention provide for a communication network comprising a Software Defined Topology (SDT) module and a query response module. The SDT module is configured to define a set of Virtual Functions and logical connections therebetween, for example as specified in a Forwarding Graph. The Virtual Functions and logical connections may then be instantiated for example by operation of network reconfiguration functions such as Software Defined Networking and/or Network Function Virtualization. The Virtual Functions utilize hardware resource components of the communication network, for example directly or indirectly via a virtualization layer, such that the virtual functions may be provided on top of one or more intermediate layers of virtualized resources. In various embodiments, the SDT module may interact with Software Defined Networking (SDN) and Network Function Virtualization (NFV) functionalities. For example, the SDT module may interact with an SDN module which is used for provisioning and/or instantiating logical connections defined by the SDT module. The hardware resource components may correspond to general-purpose components of a network which can be used to instantiate various networking functions and/or application functions in accordance with a virtualization scheme. These may be relatively generic servers or computing equipment, such as commercial-off-the-shelf hardware which can be configured to provide various networking and/or computing functionalities. The query response module is part of a Database Management System (DBMS) and is configured, in response to a database query, to invoke the SDT module to define a set of database functions belonging to the set of Virtual Application Functions. Instantiation of defined database functions is performed in accordance with a query execution plan. The database functions may include distributed storage functions, distributed processing functions, or the like. In some embodiments, the SDT module and the query response module may be integrated together.

The query execution plan may be provided in various ways, for example by the query response module, provided by the SDT module, or provided by a combination of the query response module and the SDT module. In some embodiments, the SDT module is configured to define the database functions and their logical connections according to a query execution plan which is provided to the SDT module, for example as previously generated by the query response module. In some embodiments, the SDT module is configured to receive a previously generated query execution plan and to further modify and/or improve the previously generated query execution plan by performing further optimization. In some embodiments, the SDT module is configured to define or generate a query execution plan, for example in the case that no previously generated query execution plan is provided. The SDT module may be configured to perform combinations of the above possibilities as required, for example to use or improve a previously generated query execution plan when so instructed or to generate a query execution plan when so instructed.

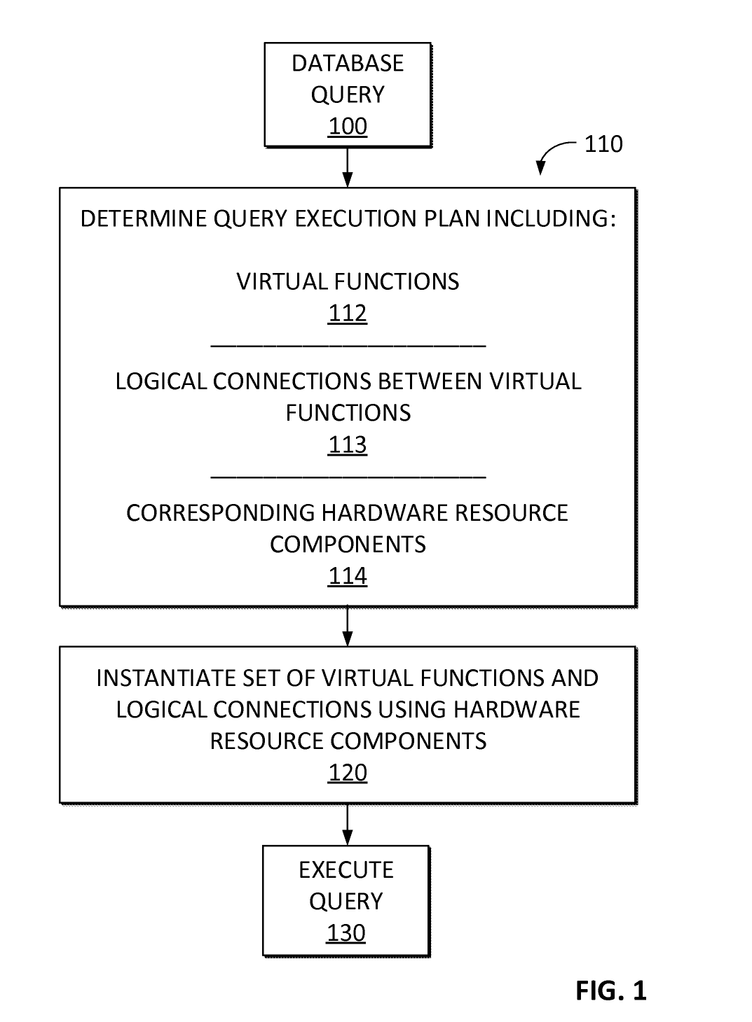

Embodiments of the present invention provide for a method for providing database functionality in a communication network. Having reference to FIG. 1, the method includes determining 110, in response to a database query 100, a query execution plan comprising an indication 112 of a set of Virtual Functions, an indication 113 of logical connections between the set of Virtual Functions, and an indication 114 of a set of hardware resource components of the communication network for use in implementing the set of Virtual Functions. Determining the query execution plan may be performed by the query response module, the SDT module, or a combination of the two. The indications 112, 113, 114 can be provided as separate indications located in separate data fields, or they can be provided as different information contained within a common indication data field. The logical connections may imply the execution order of the Virtual Functions. The method further includes instantiating 120 the set of Virtual Functions and logical connections therebetween using the indicated set of hardware resource components. The method further includes executing 130 the query according to the query execution plan. The method may be implemented by one or more computers, virtual computing machines, or the like, as provided by computing elements of the communication network or supporting infrastructure.

In various embodiments, the query may be executed by the instantiated set of virtual functions, operating together within the network. More particularly, the virtual functions and logical connections therebetween are instantiated in the network as directed by the SDT module. The virtual functions include database-specific functions such as functions which retrieve data from the database, process the data, transmit processed or unprocessed data to other virtual functions, received data from other virtual functions, or the like, or a combination thereof. The virtual functions, which are instantiated within the network at one or more nodes according to virtualization techniques, thus operate to execute the query and forward the results of the query to a desired network location.

In some embodiments, the SDT module transmits an instruction for generating the set of virtual functions to one or more of the hardware resources of the communication network. The hardware resources are configured to collectively instantiate and interconnect the set of virtual functions. Operation of the set of virtual functions using the hardware resources then implements the query execution plan. The hardware resources therefore act to transmit, receive and process information according to steps of the query execution plan. The hardware resources may thus include a processor, memory, network interface, and the like. The hardware resources may be real or virtualized.

Some embodiments of the above-described method may include generating the query execution plan using the query response module. The method may further include transmitting the query execution plan from the query response module to the SDT module. The method may further include using the SDT module to define the above-mentioned set of virtual functions and logical connections therebetween, based on the query execution plan. The query response module and SDT module may be provided as a real or virtualized computational entity within the communication network. Thus, the query response module and SDT module operate together to generate and implement the query execution plan.

Some embodiments of the above-described method may include generating the query execution plan using the SDT module. The method may further include using the SDT module to define the above-mentioned set of virtual functions and logical connections therebetween. The method may further include receiving the database query directly by the SDT module. In such embodiments, a separate query response module may not be required, or its functions can be subsumed into the SDT module.

Some embodiments of the above-described method may include generating the query execution plan using a combination of the query response module and the SDT module. The method may include generating an initial query execution plan by the query response module and communicating same to the SDT module. The method may further include modifying the query execution plan by the SDT module.

In some embodiments, the logical connections defined by SDT are accompanied with QoS requirements, which are requirements for virtual resources. As such, in some embodiments, the query execution plan may specify hardware resource and virtual resource requirements. Alternatively, NFV and/or SDN functionalities may be used for resource management, for example in order to determine the hardware resource components and/or virtual resources.

In various embodiments of the present invention, a query execution plan is generated which is indicative of one or more additional execution points to be instantiated within the network for execution of the query. The additional execution points may be implemented within the SDT-capable network for example by instantiating Virtual Network Functions and/or Virtual Application Functions at a given network node, and configuring the associated forwarding graphs to incorporate such functions. For example, when an initial query execution plan is provided, the associated initial forwarding graph may be adjusted in accordance with the query execution plan to incorporate the additional execution points. As another example, additional execution points may correspond to network nodes which are not co-located with data that is to be used in execution of the query, nor with a specified destination for the query information. Rather the additional execution points correspond to processing nodes, which receive data from other network nodes and process and forward the received data in a specified manner. Additional execution points may therefore correspond to dedicated aggregation nodes. The additional execution points, may, for example, be used to receive database tables from upstream nodes and to perform database operations, such as join-type operations, on said tables in furtherance of query execution. Selection of the one or more additional execution points may be performed in accordance with a query optimization, in which the decision variables of the optimization include variables indicative of whether and where to instantiate processing/storage nodes for the query execution, variables indicative of how to route data between nodes and/or variables indicative of where, in terms of potential network nodes, to perform various database operations.

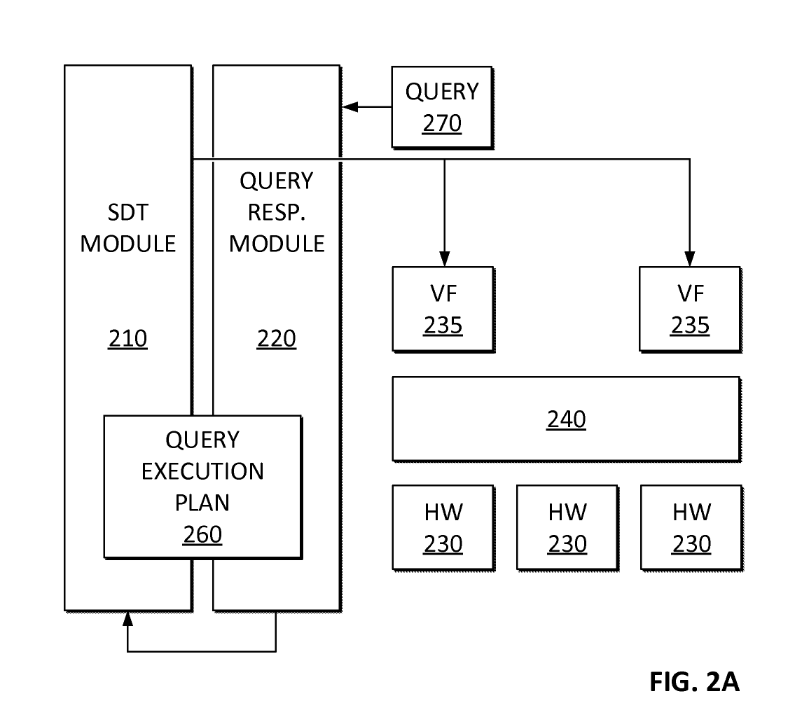

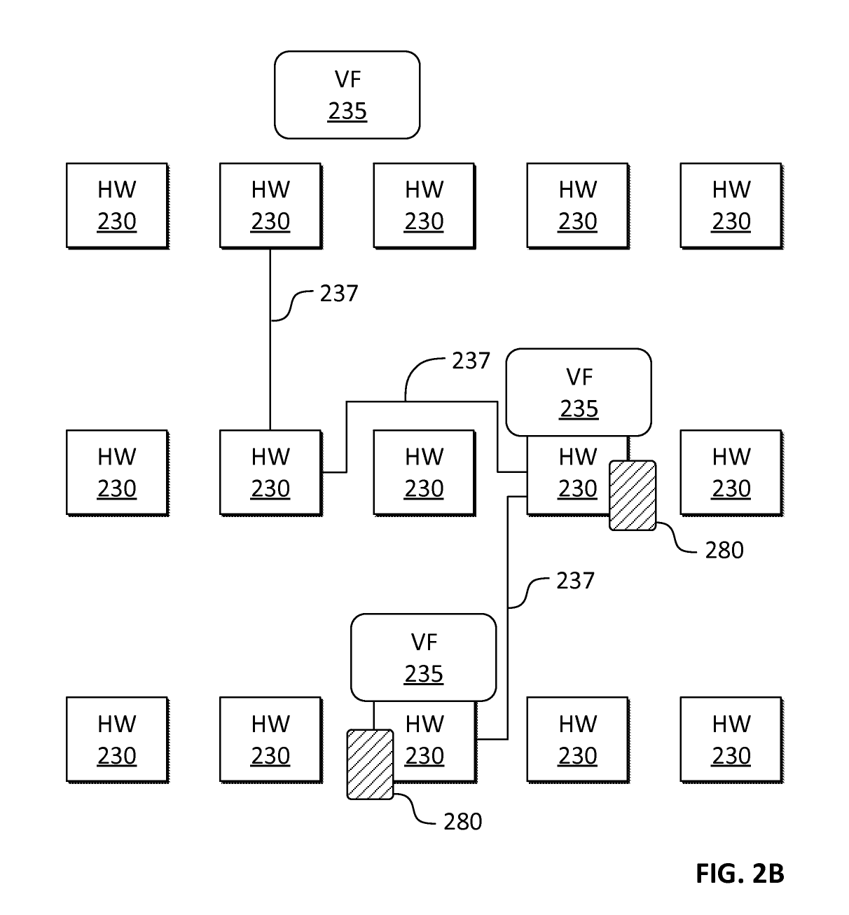

FIGS. 2A to 2B illustrate a communication network provided in accordance with an embodiment of the invention. The communication network includes a Software Defined Topology (SDT) module 210 and a query response module 220. These modules may be provided using resources of the communication network. The resources may correspond to dedicated hardware such as computer servers and networking devices, or virtual resources and/or virtual machines provided using communication network hardware such as commercial off-the-shelf hardware computer components, such as general purpose servers and storage devices. The network further comprises a set of hardware resource components 230, which may be distributed through the network. The SDT module is configured to define a set of virtual functions 235 and logical connections therebetween by utilization of the hardware resource components 230. The defined set of virtual functions and logical connections therebetween may subsequently be instantiated for example by NFV and/or SDN modules, or the like. For example, selected hardware resource components may be configured to provide nodes which receive, forward, and optionally process database information as part of execution of a database query. These nodes may be configured to provide networking, e.g. SDN functionalities and/or VNF or VAF functionalities, or a combination thereof. One or more virtualization layers 240 and associated virtual resources may be provided between the hardware resource components 230 and the virtual functions 235.

The query response module 220 is configured, in response to a database query, to invoke the SDT module 210 to define, for instantiation, at least the particular illustrated virtual network functions 235, namely functions such as database functions which support execution of a database query 270 provided to the network. The database query may be provided by a service customer, a user, an application running on a device, network node, virtual network node, or the like. The database query can include various information such as an SQL query statement or other parameters forming a query of information known or assumed to be held in the database. The database query 270 is received by the query response module 220 which subsequently interacts with the SDT module 210, for example by sending the query or query execution plan to the SDT module, or otherwise triggering the SDT module by transmitting a message thereto. Instantiation of the database functions is performed in accordance with a query execution plan 260 which may be generated by the query response module 220 and/or the SDT module 210. As such, the query execution plan may be provided by cooperative configuration of the query response module and the SDT module. Generation of the query execution plan may comprise query optimization pertaining to providing an efficient query satisfying predetermined objectives and constraints. The database functions may include distributed storage functions, distributed processing functions, or the like.

FIG. 2B illustrates an example collection of hardware resource components 230, some of which are used to instantiate Virtual Network Functions 235 for supporting a query execution plan 260. The VNFs 235 may correspond to database node functions. Links 237 between the hardware resource components 235 are also illustrated. The links 237 may be provisioned on direction of the SDT module 210, in furtherance of the query execution plan 260. In some embodiments, at least some of the instantiated Virtual Network Functions 235 are co-located with database tables 280 stored in memory of hardware resource components.

### Software Defined Topology

Software Defined Topology (SDT) as used herein refers to a networking technology that facilitates at least network virtualization. SDT may interoperate with Software Defined Networking (SDN) components and Network Function Virtualization (NFV) components to instantiate and provision virtual networks. For example, NFV may be used to instantiate Virtual Functions at specified locations, while SDN may be used to provision logical links to form a virtual network. Various aspects of both SDN and NFV would be readily understood by a worker skilled in the art.

In some embodiments, SDT is used to generate and/or determine a Virtual Function Forwarding Graph (VF FG) for a given service. The VF FG may be derived by augmenting a Virtual Application Function Forwarding Graph (VAF FG) with Virtual Network Functions. The VAF FG may be provided by the application being implemented, or in accordance with embodiments of the present invention, the VAF FG may be generated as part of a query execution plan. Forwarding graphs may specify logical links between network nodes that can be unidirectional, bidirectional, multicast, and/or broadcast.

In some embodiments, SDT is used to translate a VF FG to a network logical topology. The topology may reflect point-of-presence decisions indicative of physical locations and/or network addresses at which to implement virtual functions. The topology may additionally or alternatively reflect decisions regarding how to logically link service traffic sources, the locations at which virtual functions are implemented, service traffic destinations, and respective resource requirements.

In various embodiments as described herein, SDT may be used to offer Virtualized Database Management Systems (V-DBMS) as services. In this case, VAFs may correspond to distributed database storage functions. As such, the network may be used to provide storage resources for use by network users. Various embodiments of the present invention provide for a query execution and/or query processing facility of the V-DBMS, by which query execution plans are generated and/or implemented. Generation of query execution plans may comprise query optimization operations, for example. Further, in various embodiments, query optimization is performed by SDT-enabling components of the network, for example in order to facilitate a desired, or optimal, level of performance at both the network level and at the application level. Performance level may be measured in terms of parameters such as delay, network and/or computing resource usage, operational costs, interference with other network functions, end user experience, or the like, or a combination thereof.

In various embodiments of the present invention, SDT design and interface features may be extended in order to facilitate query execution plan generation and/or query optimization in support of a V-DBMS. This may facilitate efficient V-DBMS operation and query execution thereof, for example. Further, various embodiments of the present invention may provide for additional inputs to the SDT-enabling components of the network, such as inputs accepting database queries. Yet further, various embodiments of the present invention may provide for an interface between the SDT-enabling components of the network and the V-DBMS.

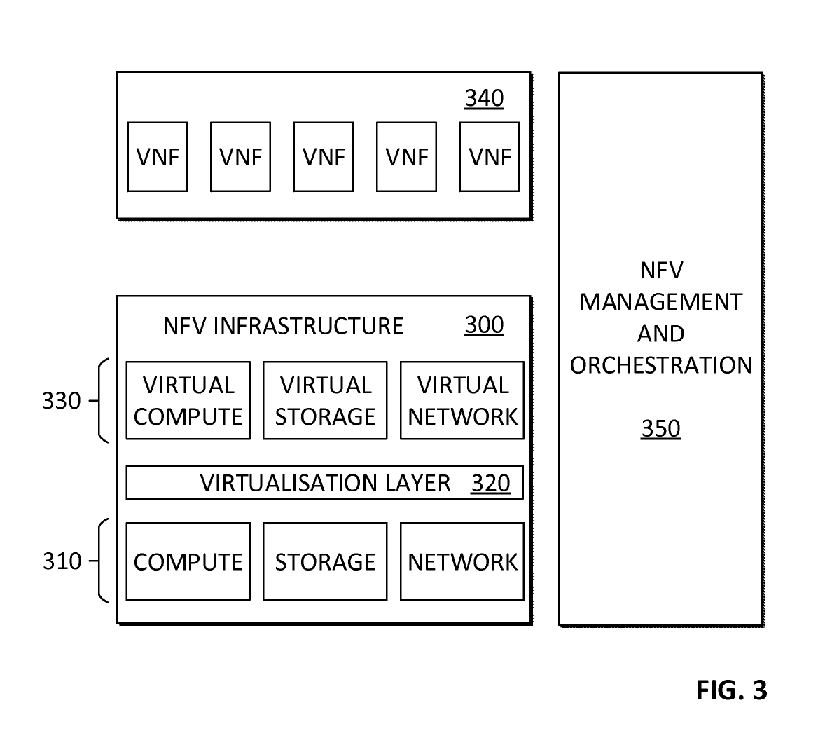

FIG. 3 illustrates an example of an NFV framework in accordance with the prior art, as disclosed in “Network Function Virtualisation (NFV); Architectural Framework,” ETSI GS NFV 002, V1.1.1, October 2013, European Telecommunications Standards Institute (ETSI), and available at: http://www.etsi.org/deliver/etsi_gs/NFV/001_099/002/01.01.01_60/gs_NFV002v010101p.p df. As illustrated, the NFV framework includes NFV infrastructure 300 which includes hardware resources 310, such as computing, storage and networking resources, a virtualization layer 320, and virtual computing, storage and networking resource 330. Virtualized Network Functions 340, such as software implementations of network functions, are capable of running over the NFV infrastructure 300. NFV management and orchestration 350 is also provided, which covers the orchestration and lifecycle management of physical and/or software resources that support the infrastructure virtualization, and the lifecycle management of VNFs.

A communication system according to an embodiment of the present invention includes a data plane and a control plane. The data plane is configured to transport network traffic for a service among a plurality of physical network nodes that compose a physical infrastructure. The service may correspond to a V-DMBS. The control plane includes a software defined topology (SDT) module. The SDT module is configured to receive service parameters for the service. The SDT module is further configured to locate logical network nodes for a service-specific data plane logical topology at respective physical network nodes among the plurality of physical network nodes according to the service parameters, a service-level topology for the service, and the physical infrastructure. The SDT module is further configured to define connections among the logical network nodes according to the service parameters, the service-level topology, and the physical infrastructure, and define respective connections for a plurality of UEs to at least one of the logical network nodes according to the service parameters, the service-level topology, and the physical infrastructure. The SDT module is further configured to define respective functionalities for the logical network nodes.

Various embodiments of the present invention provide for an apparatus for providing virtualized database management. The apparatus may include a dedicated computing component or one or more virtualized computing components provided by resources within a communication network, for example as virtual network functions or virtual application functions.

NFV enables network functions that are traditionally tied to hardware to run on a cloud computing infrastructure in a data center, thereby allowing the separation of network functions from the hardware infrastructure. SDN is an architectural framework for creating intelligent programmable networks, where the control planes and the data planes are decoupled, network intelligence and state are logically centralized, and the underlying network infrastructure is abstracted from the application. In embodiments of the present invention, the control plane may use customer information and provide information to form a network logical topology, for example as created via SDT. The SDT can be combined with the SDN and software defined protocol (SDP) to create a customized virtual network (VN). A virtual network is a collection of resources virtualized for a particular service. Customers include users of services via a UE, terminal, or other customer device. Providers include service providers, VN operators, and other providers of services over the wireless network.

In some embodiments, SDT provides a framework for software defined services and/or content delivery that allows operators to define on-demand and service specific data plane architecture, i.e., logical topology, to enable more efficient use of network resources and ensure quality of experience (QoE) to customers. SDT can be used to configure a V-DBMS. SDT can map service level logical topology to data plane logical topology before the VN is formed. The mapping produces a service-specific data plane logical topology, which can be referred to as the customized VN topology or simply VN topology. For each application, service, or VN, the SDT can determine an on-demand and customized logical data plane topology. The SDT can select physical locations of logical network nodes for the logical data plane. The SDT can also define the topology of the nodes in the data plane topology. Additionally, the SDT can define service-specific data process functionalities for logical nodes in the data plane logical topology. A logical node is a software defined entity implemented at a physical network node that can assume a variety of roles and perform various functions. A logical node can be a user-specific virtual serving gateway (v-u-SGW), a service-specific virtual serving gateway (v-s-SGW), or a content container, among other roles. The SDT determines the data plane logical topology for each application, service, or VN according to requirements from the operators or customers of the application, service, or VN. These requirements can include QoE and quality of service (QoS). The SDT may also determine the data plane logical topology according to the service level logical topology, service traffic characteristics, customer distribution, mobility speed predictions, and traffic load predictions, among other parameters. The SDT can allow the data plane logical topology to adapt to changes in traffic load and traffic load predictions, network node capabilities, and mobility of customer devices. It is further realized herein the SDT can be managed by network providers, VN providers, or customers.

In some embodiments, SDT can allow harmonized network virtualization. It can generate/determine a network logical topology jointly for each service, such as each V-DBMS service or portion thereof, including (1) virtual function points of presence (PoP) decision, i.e., physical locations (network addresses) of virtual functions, and (2) local link decisions, i.e., logical links between service traffic sources, service VF PoPs, and service traffic destinations, and respective resource requirements.

Instead of manually defining the logical topology for a network service, SDT may comprise automatic definition and/or creation of the logical topology from the network service request. In some embodiments, a database query may be treated as a service request. The role of SDT may include determining the VNF FG (which defines the logical topology). The VNF FG may define the virtual functions, the ordering of the virtual functions, and the connection between the virtual functions. In some embodiments, the role of SDT may include determining the number of instances of each function in the FG, determining the forwarding paths (e.g., for the control plane and data plane), and/or determining the PoP for each function in the VNF FG (which defines the physical topology). The PoP of the virtual functions and the connection between the virtual function PoPs may be defined in the network logical topology. The SDT entity can therefore operate as a topology manager. In some embodiments, the role of the SDT may include defining only the VNF FG. In some embodiments, SDT may be configured to define both VNF FG and the corresponding network logical topology. In other embodiments, SDT may be configured to define only the network logical topology, without necessarily defining the VNF FG. SDT can be combined with NFV, in which case, SDT can potentially also be a virtual function that is instantiated in accordance with NFV. If SDN can also be used to split the control plain and the data plane then there may be a defined interface between the SDN controller and SDT. Since SDT provides the logical topology for the NS request to the orchestrator, there should be a defined interface between SDT and the orchestrator. After SDT's decision making, NFV and SDN are used to provision resultant service-specific network topologies. NFV is used to instantiate service functions, while SDN is used to provision the physical connections under-laying the logical connections.

### Query Execution Plan

In general, a query execution plan specifies an ordered set of steps used for accessing data in a DBMS, such as a V-DBMS. The query execution plan may comprise a sequence of database operations, such as Structured Query Language (SQL) operations for accessing data in an SQL DBMS. For example, candidate operations may include join, semi-join, outer join, inner join, theta join, anti-join, and the like. For a distributed DBMS, query execution plans may also include a plan and/or corresponding instructions for moving data between data storage locations of a corresponding distributed database. A query execution plan may be generated as the result of an optimization operation, such as a cost-based or rule-based optimization.

Whereas existing database query execution plans are typically generated by optimization over decision variables such as those pertaining to join ordering and (in the case of a distributed DBMS) data movement, embodiments of the present invention additionally generate a query execution plan in accordance with an optimization over traditional decision variables as well as further decision variables relevant to SDT-capable networks. For example, the further decision variables may relate to Virtual Function Point of Presence (VF PoP) decisions, pertaining to physical and/or network logical locations of various VFs used for query execution and supporting query execution. In various embodiments, the VF PoP decision variables may correspond to one or both of VNF PoP decision variables and VAF PoP decision variables. VAF PoP decision variables may pertain more directly to query execution where the VAFs include query processing functionalities. VNF PoP decision variables may not be present in all embodiments. Where VNF PoP decisions are present, they may pertain to configuration decisions of the network supporting the query execution in order to further support efficiency thereof. Query execution support may comprise networking and/or network configuration operations, for example. In some embodiments of the present invention, generation of the query execution plan includes evaluating one or more alternative plans which introduce additional execution points within the network, which may be introduced dynamically and used to perform operations such as join-type operations. The introduction of such additional execution points may correspond to decision variables which pertain to locations in the network at which to instantiate VNFs and/or VAFs to support execution of the query. Execution points may be instantiated within the network for the express purpose of executing a query or a limited set of queries, and subsequently abandoned or de-instantiated, either immediately or after a predetermined idle period. The SDT-capable network may therefore be integrated with the distributed DBMS and adapted in terms of nodes, node capability, node interconnection, or the like, in order to support query optimization.

In various embodiments, the query execution plan is approximately optimized with respect to an objective function, which evaluates performance and/or cost. Factors affecting performance and cost may include one or more of: data bandwidth usage, network resource usage, memory usage, processor usage, monetary cost in the case of leased resources, extrinsic costs imposed for network administration purposes, latency, amount of computation, bandwidth usage, and the like. Various ones of these factors may be combined or used on their own to derive a suitable objective function. Further, various ones of these factors may be combined or used on their own to derive one or more suitable constraint functions. Objective functions and constraint functions are functions of at least the various relevant decision variables or subsets thereof.

Some embodiments are configured to generate an optimal or quasi-optimal query execution plan which takes into account data movement costs and network resource usage, for example.

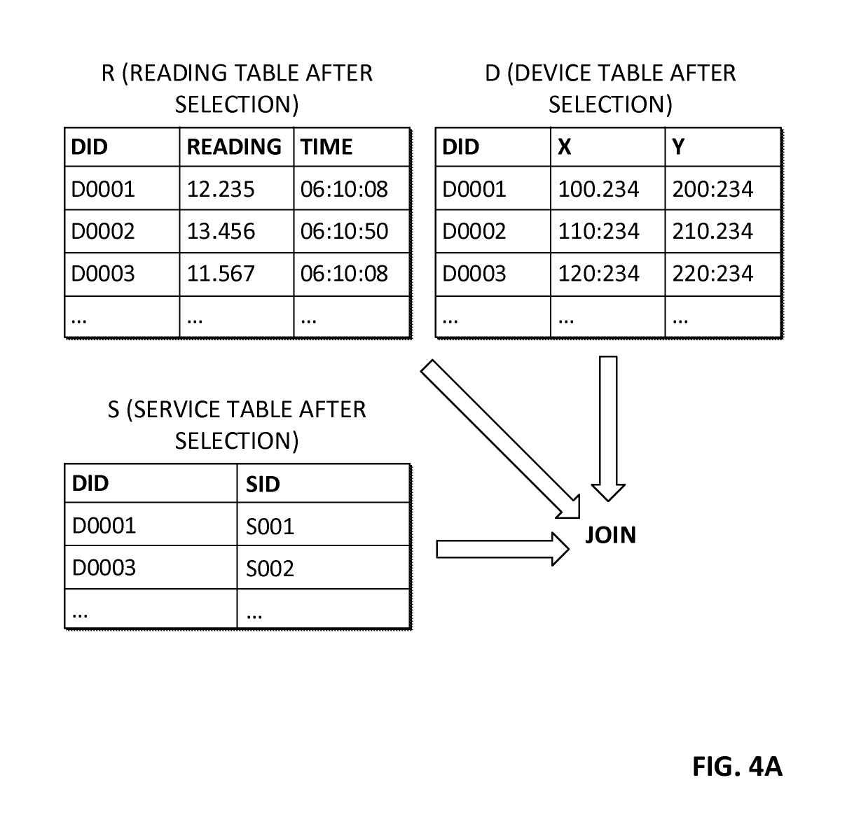

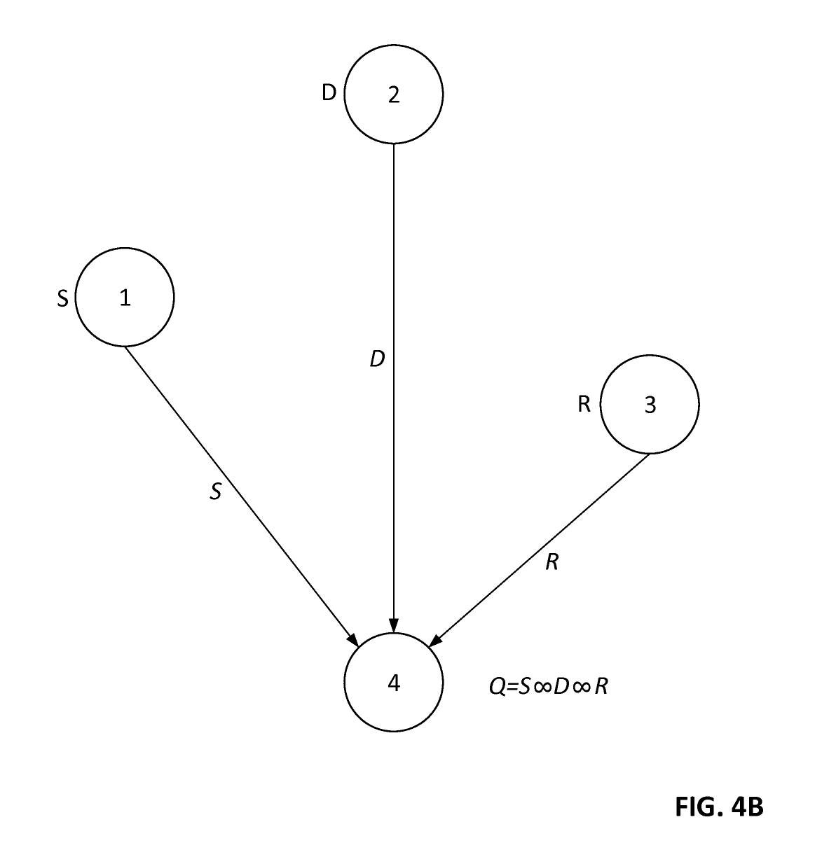

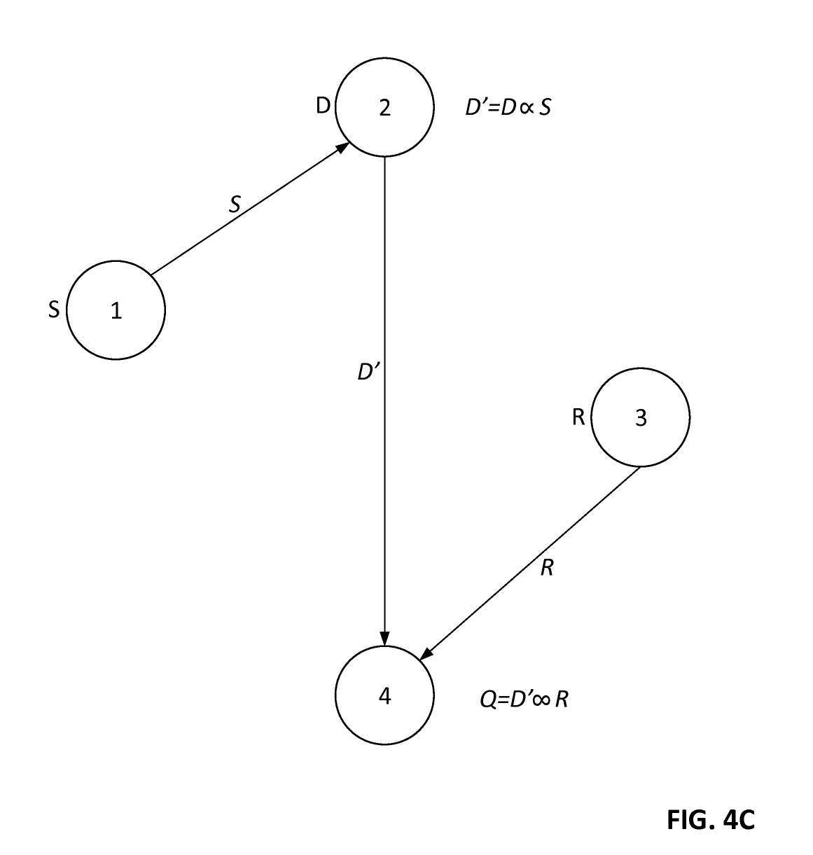

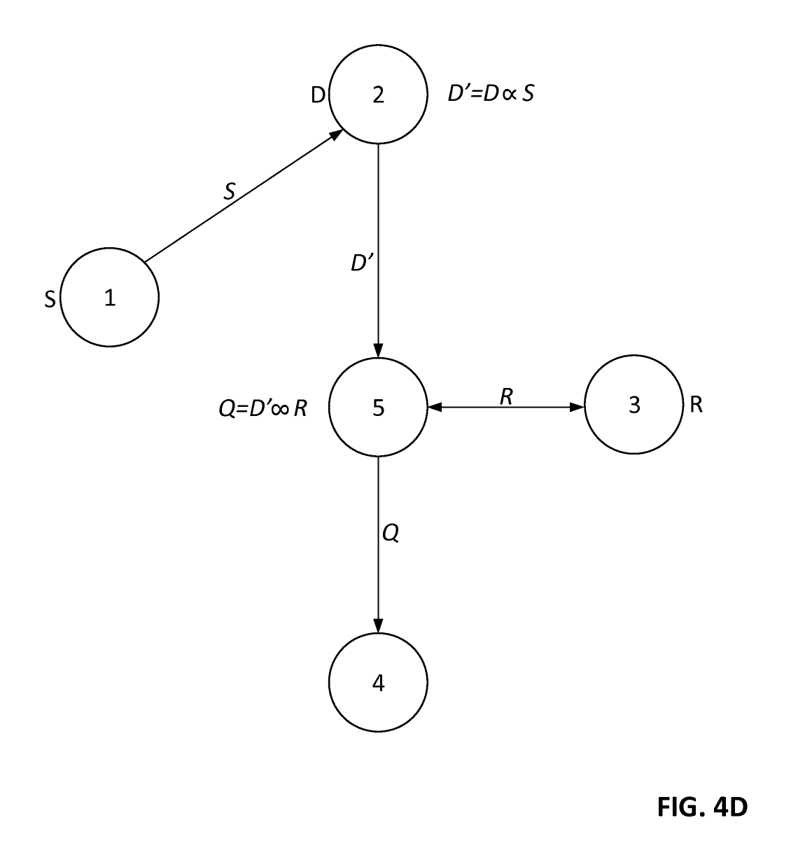

FIGS. 4A to 4D illustrate a query situation along with several alternative query execution plans and evaluation criteria, in accordance with an illustrative example embodiment of the present invention. This example may pertain to a network of devices configured to take and record sensor readings. The example database, as illustrated in FIG. 4A, includes three tables: R, S and D. Table R lists device IDs (DID), reading values, and reading times. Table S lists associations between device IDs and service IDs (SID). Table D lists device locations in terms of X and Y coordinates. Consider the following SQL query:

“Select DID, X, Y, Reading, Time from R join D join S where SID=S001 or SID=S002.”

Execution of the query requires joining of the three tables R, S and D. Referring to FIGS. 4B to 4D, assume that network nodes 1, 2 and 3 contain the table data for S, D and R, respectively, and that the query result is required at network node 4. In the first option, illustrated in FIG. 4B, the data from each of nodes 1 to 3 is communicated directly to node 4, and the join operations are performed at node 4. In the second option, illustrated in FIG. 4C, the data from node 1 is communicated to node 2, where a first semi-join operation is performed to yield a table D′. The semi-joined data D′ is then communicated from node 2 to node 4. Also the data from node 3 is communicated separately to node 4. A join operation is performed at node 4 to join D′ to R, thereby joining S, D and R. The third option, illustrated in FIG. 4D, proceeds similarly to the second option, except a further node, node 5, is dynamically generated as a new execution point. The data from nodes 2 and 3 are communicated to node 5, where the join of D′ to R is executed. The result Q of this join operation is then communicated to node 4.

It is noted that the third option involves an integration of SDT with DBMS which is significantly different from prior art implementations. For example, a traditional distributed DBMS exists as a separate system, independent of the network, and is not able to generate a query execution plan that dynamically introduces new execution points.

Potential performance and cost metrics for the above options may be as follows, assuming |X| is the size of table X, bᵢⱼ is the bandwidth of the logical link between nodes i and j, and Cᵢⱼ is a cost associated with usage of the logical link between nodes i and j. For the first option, the performance is given by Max(|S|/b₁₄, |D|/b₂₄, |R|/b₃₄) and the cost is given by |S|C₁₄+|D|C₂₄+|R|C₃₄. For the second option, the performance is given by Max(|S|/b₁₂+|D′|/b₂₄, |R|/b₃₄) and the cost is given by |S|C₁₂+|D′|C₂₄+|R|C₃₄. For the third option, the performance is given by Max(|S|/b₁₂+|D′|/b₂₅, |R|/b₃₅)+|Q|/b₅₄ and the cost is given by |S|C₁₂+|D′|C₂₅+|R|C₃₅+|Q|C₅₄.

As the parameters in the above performance and cost equations vary, different ones of the three options will emerge as the best candidate, for example in terms of a given objective function indicative of a weighted trade-off between performance and cost, and subject to constraints on the costs. Query optimization may comprise determining the best among these and potentially other candidates for a given realization of the parameters.

### SDT Involvement in Query Execution Plan

Various embodiments of the present invention invoke SDT capabilities of the network, for example as embodied in an SDT module, to generate the query execution plan, for example via query optimization. In this case, the generated query execution plan may comprise or be provided as a Virtual Application Function Forwarding Graph (VAF FG).

In some embodiments, the SDT-capable network may be configured to provide a virtual network on demand, with different virtual networks being provided for different service customers and/or with a different virtual network being provided for each different query or set of queries. Database queries may be regarded from the perspective of the network as service requests, which are satisfied in part by the dynamic creation of an appropriate virtual network and corresponding resource allocation.

As such, in some embodiments, the SDT-capable network may be configured to receive database queries, such as SQL query statements, as input and, in response, to trigger generation of a query execution plan and subsequent execution of the query using the generated plan.

In various embodiments, generation of a query execution plan, for example via query optimization and performed by the query response module and/or SDT module, may comprise accessing database and/or table schema information. The database schema may be indicative of the structure of the database, its organization, the location of data, such as the location of various tables, and the like; the table scheme may be indicative of the structure of the table, its organization, and the like. In some embodiments, database or table schema information may be embedded in a query-specific service request. The service request may be a query which is related to remotely stored data, for example. In some embodiments, database or table schema may be maintained by the network in a predetermined real and/or virtual storage repository. In some embodiments, the database or table schema may be stored in a service descriptor associated with the creation of the V-DBMS service being provided. In such a case, and in some embodiments, the query service may have a dependency on the previous V-DBMS service. Information indicative of the size of involved tables at distributed storage locations may be embedded in the query-specific service request or else obtained through communication with the respective data locations.

In some embodiments, a customer, application, V-DBMS service, or the like, may provide a query statement, such as an SQL query as a service request to the SDT-capable network. Table sizes indicative of data tables to be processed in furtherance of the query response may also be provided, for example by the customer, application or V-DBMS service, along with the query statement. The SDT module may be configured to access information regarding the table schemas and table locations and to generate a query execution plan based on the provided and accessed information, for example via query optimization. The SDT module may generate a VAF FG as part of the generated query execution plan.

In some embodiments, rather than table sizes being provided extrinsically, the SDT module may be configured to determine relevant table sizes for example by interrogating data locations provided as virtualized storage functions.

In some embodiments, the customer, application, V-DBMS service, or the like, may provide an initial query execution plan, for example encoded as an initial VAF FG. The SDT module may incrementally adjust the query execution plan for example to further optimize same. By starting with an initial VAF FG, optimization computation by the SDT module may be reduced. In this approach, table sizes may either be provided extrinsically or determined by the SDT module. Regardless of whether the SDT module or other function of the present system generates the query execution plan (VAF FG) based on an abstract function description such as a query statement, or incrementally based on an initial plan, embodiments of the present invention comprise the generation of the query execution plan at least in part in conjunction with SDT functionalities of the communication network.

Embodiments of the present invention may utilize conventional query optimization and/or query execution plan generation approaches in conjunction with the further approaches as described herein. For example, generation of a plan sequence of join operations or a plan sequence of joins interleaved with semi-joins may be provided in accordance with conventional methods. Approaches for query optimization may include, for example, those described in “The State of the Art in Distributed Query Processing,” Donald Kossmann, ACM Computing Surveys, 2000.

In some embodiments, generation of the query execution plan may comprise determining logical flow aspects of the plan for example as represented by a VAF FG, and subsequently making a VAF Point of Presence (PoP) decision indicative of the physical and/or network logical locations of the VAFs and their logical connectivities. In some embodiments, the VAF FG may correspond to logical flow portions of the query execution plan, including for example sequences of join type operations, for example as determined by conventional approaches. Logical links between VAF PoPs may be defined by the VAF FG, which may be provided as an input. The provisioning of logical links between VAF PoPs, which may correspond to the logical flow, may be performed by an SDN functionality.

The VAF PoP decision may correspond to a portion of the query optimization which is performed separately or integrally with the conventional portions of the query optimization. As an example, the VAF PoP optimization may be configured to determine optimal or quasi-optimal location of VAFs, for example VAFs relating to required SQL operations in furtherance of execution of a particular SQL query. The optimization may in some embodiments also minimize considerations such as latency and traffic related costs for the particular SQL query. VAF PoP decisions may be made for example given the physical or network logical locations of relevant database information in the network corresponding to data required to execute a given query, as well as the physical or network logical locations of the entity to which the query response is to be delivered. In some embodiments, VAF PoP decisions are made given prior VNF PoP decisions. In other embodiments, VNF PoP decisions may be made in cooperation with VAF PoP decisions.

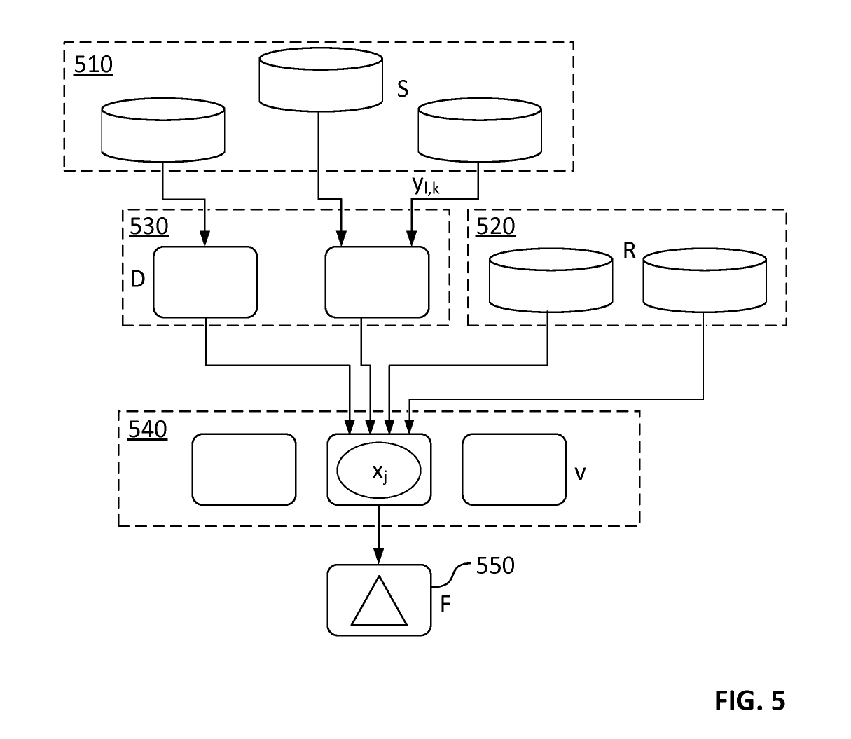

FIG. 5 illustrates an example of a network configuration in which S 510 corresponds to a set of database components which are indirectly accessible but not directly accessible by an entity which initiates the query, for example a customer, application, V-DBMS service, or the like, R 520 corresponds to a set of database components which are directly accessible, D 530 corresponds to a set of database components which belong to a set of intermediate access nodes from which S can be accessed directly, V 540 corresponds to a NFV-enabled container node set at which additional nodes may potentially be instantiated in support of the query execution, and F 550 corresponds to a (possibly unitary) set indicating the destination for the query result. The database components in each set may correspond to hardware resources at which particular data of the database resides, for example. In some embodiments, S, R and D may correspond to the same sets S, R and D of FIGS. 4A to 4D. Alternatively, the set naming convention of FIG. 5 may be self-contained.

In the present embodiment, the problem of determining a desirably efficient solution indicating the Points of Presence for VNFs used in support of a query execution plan can be cast as follows. For nodes l and k belonging to the sets S, R, D, V and F, let y_{l,k} denote the presence of a link between node l and node k. Further, for nodes j belonging to the sets V and F, let xⱼ denote the presence of a target node which is instantiated and used for performing join-type operations. Such a node j may be similar to the node 5 as illustrated in FIG. 4D. The decision variables of the optimization problem are y={y_{l,k}:l,k in S, R, D, V and F} and x={xⱼ:j in V and F} and have binary values on the set {0,1}. The optimization problem involves determining a suitable set of decision variables which substantially maximizes (or substantially minimizes) a given objective function, optionally subject to a given set of constraints. Thus, the PoP decision is indicative of nodes at which to instantiate certain VNFs, such VNFs supporting SQL operations, as well as links between nodes to be provisioned for passing information such as database tables. In some embodiments, link provisioning may be performed via SDN, while VNF instantiation may be performed via NFV.

In some embodiments, the optimization may account for factors such as latency between nodes, anticipated traffic generated between nodes, cost of traffic between nodes, and maximum allowable traffic rates. For example, for nodes i and j belonging to the sets S, R, D, V and F, let d_{i,j} represent the latency between pairs of nodes, q_{i,j} represent the traffic volume transferred from node i to node j in support of the query execution, c_{i,j} represent the per-unit cost of traffic transfer from node i to node j, and Tⱼ represent the maximum incoming traffic rate allowed at node j. The optimization problem can thus be expressed as follows:

Determine x and y (with elements xⱼ and y_{l,k}) so as to minimize objective function O(x,y) subject to plural constraints Cₖ, where, for example:

$$O ( x , y ) \text{:} {min}_{x , y} {ω}_{1} [ {\sum }_{j = 1}^{\vert V \vert + 1} max ( {⋃}_{i = 1}^{\vert R \vert} {d}_{i , j} {x}_{j} , {⋃}_{k = 1}^{\vert D \vert} [ {d}_{k , j} + max ( {⋃}_{l = 1}^{\vert S \vert} {d}_{l , k} {y}_{l , k} ) ] {x}_{j} ) + {d}_{j , F} {x}_{j} 1 ( j \neq F ) ]$$

$${C}_{1} ( x ) \text{:} {\sum }_{i = 1}^{\vert D \vert + \vert R \vert} \frac{{q}_{i , j} {x}_{j}}{{d}_{i , j}} + {ω}_{2} [ {\sum }_{j = 1}^{\vert V \vert + 1} ( {\sum }_{i = 1}^{\vert R \vert} {q}_{i , j} {c}_{i , j} {x}_{j} + {\sum }_{k = 1}^{\vert D \vert} {q}_{k , j} {c}_{k , j} {x}_{j} + {q}_{jF} {c}_{j , F} {x}_{j} 1 ( j \neq F ) ) + {\sum }_{l = 1}^{\vert S \vert} {q}_{l , k} {c}_{l , k} {x}_{l , k} ] ∀ j ∈ V$$

$${C}_{2} ( y ) \text{:} { \sum }_{k ∈ D} {\sum }_{l = 1}^{\vert S \vert} {y}_{l , k} \leq \vert S \vert$$

$${C}_{3} ( y ) \text{:} {\sum }_{k = 1}^{\vert D \vert} {y}_{l , k} = 1 ∀ l ∈ S$$

$${C}_{4} ( x ) \text{:} {\sum }_{j = 1}^{\vert V \vert + 1} {x}_{j} = 1$$

and such that xⱼ and y_{l,k} belong to {0,1} for all j, l, k.

Generally speaking, O(x,y) reflects a cost function reflecting a weighted sum of both latency of a given proposed solution and traffic volume associated with the proposed solution. The weighting factors ω₁ and ω₂ can be adjusted. Additionally, the objective function may be adjusted in various ways, for example to weight different portions of the objective function differently, to introduce terms such as those reflected in the constraints, or to introduce other objective terms such as those reflecting a number of nodes, a number of links, impacts on the network, and the like.

C₁(x) reflects the constraint that, if an aggregation node xⱼ is instantiated in set V, then the incoming traffic rate from all nodes in D and R that are connected to this aggregation node should respect the maximum allowable rate to same.

C₂(y) reflects the constraint that the number of links between nodes in S and nodes in D should be no greater than the size of S. As such, the number of links out of set S is limited for efficiency. In some embodiments, this constraint may be relaxed, discarded, or replaced by a different constraint.

C₃(y) reflects the constraint that the fan-out from each node l belonging to the set S of indirectly accessible database components, should be exactly one. As such, nodes in S should connect to exactly one node in D. In some embodiments, this constraint may be relaxed, discarded, or replaced by a different constraint.

C₄(x) reflects the constraint that there should be only one instantiation of a node xⱼ in set V or F, for example a node which receives and joins data from other nodes. In some embodiments, this constraint may be relaxed, discarded, or replaced by a different constraint. For example, a limited number of such nodes, greater than one, may be allowed. Such nodes may be characterized as aggregation nodes.

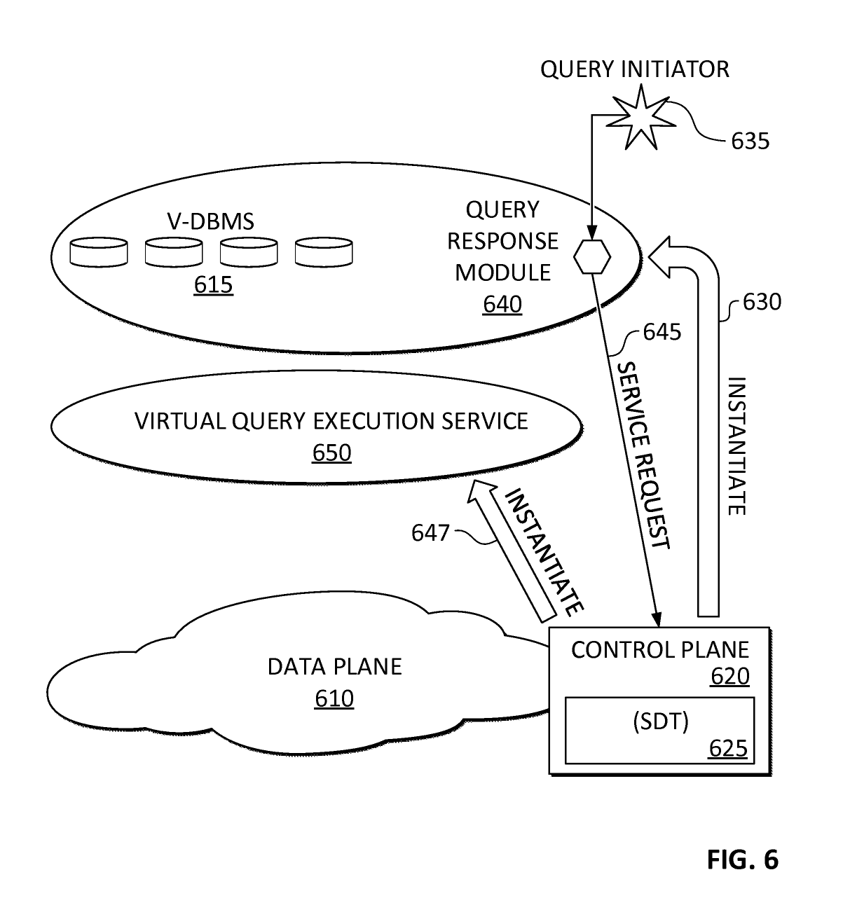

FIG. 6 illustrates operation of an embodiment of the present invention relative to a network architecture. In particular, aspects of both a physical network and a virtual network operate together in response to a database query. The network includes a data plane 610 and a control plane 620. The data plane carries user and application traffic while the control plane controls software defined topology for the virtual network. The control plane may include the SDT module 625.

In operation, the control plane may instantiate 630 a V-DBMS service 615, for example using the SDT module. A query initiator 635, such as an application or a V-DBMS user, submits a query to the query response module 640 of the V-DBMS. The query initiator 635 may be a client device such as a mobile device, application operating on network infrastructure computing equipment, or the like. The query response module 640 may be an apparatus provided within the network. For example, the query response module may comprise a dedicated networked information processing device or an application running on network infrastructure equipment. In some embodiments, the query response module may run in a virtualized environment or directly on a predetermined computing device.

The query response module 640 requests 645 the SDT module 625 to create a virtual query execution service 650 for the query. The SDT module 645 instantiates 647 such a service and notifies the query response module 640. Upon notification, the query response module 640 triggers the execution of the virtual query execution service 650. At the end of the execution, results are returned to the query response module and/or directly to the query initiator 635. The results are based on the query response. When the query response module 640 is informed about the termination of the query execution, the query response module may inform the SDT module 625 to terminate the virtual query execution service.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Various embodiments of the present invention utilize real and/or virtual computer resources. Such computer resources utilize, at a hardware level, a set of one or more microprocessors operatively coupled to a corresponding set of memory components which include stored program instructions for execution by the microprocessors. Computing resources may be used to provide virtual computing resources at one or more levels of virtualization. For example, one or more given generic computer hardware platforms may be used to provide one or more virtual computing machines. Computer hardware, such as processor resources, memory, and the like, may also be virtualized in order to provide resources from which further virtual computing machines are built. A set of computing resources which are allocatable for providing various computing resources which in turn are used to realize various computing components of a system, may be regarded as providing a distributed computing system, the internal architecture of which may be configured in various ways.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A communication apparatus comprising:
a Software Defined Topology (SDT) module configured to define a set of virtual functions and logical connections therebetween for instantiation using hardware resource components of a communication network;
the SDT module further configured to define a set of database functions belonging to the set of virtual functions in accordance with a query execution plan after the SDT is invoked in response to a database query.

2. The communication apparatus of claim 1, wherein the SDT module is configured to receive the database query from a query response module of database management system (DBMS).

3. The communication apparatus of claim 2, wherein the SDT module is configured to generate the query execution plan in accordance with the database query.

4. The communication apparatus of claim 1, wherein the SDT module is configured to receive the query execution plan from a query response module of database management system (DBMS), wherein the query execution plan is generated by the query response module in accordance with the database query as received by the query response module.

5. The communication apparatus of claim 1, the SDT module further configured to transmit an instruction for generating the set of virtual functions to one or more of the hardware resources of the communication network, wherein the one or more of the hardware resources are configured to collectively instantiate and interconnect the set of virtual functions, the hardware resources further configured, via operation of the set of virtual functions, to execute the query execution plan.

6. A communication network comprising:
a Software Defined Topology (SDT) module configured to define a set of Virtual Functions and logical connections therebetween for instantiation using hardware resource components of the communication network;
a query response module of a Database Management System (DBMS) configured to receive a database query and to invoke the SDT module to generate in association with nodes of the communication network and in accordance with a query execution plan, a set of database functions belonging to the set of Virtual Functions.

7. The communication network of claim 6, wherein the set of database functions are virtual functions operated by the communication network.

8. The communication network of claim 6, wherein the query execution plan is indicative of instantiating one or more nodes to process database information.

9. The communication network of claim 6, wherein the query response module and the SDT module are cooperatively configured to provide the query execution plan in accordance with a query optimization operation, the query execution plan satisfying one or both of a predetermined set of objectives and a predetermined set of constraints, said objectives and constraints pertaining to efficiency of the database query, wherein defining of the set of database node functions is based on output of the query optimization operation.

10. The communication network of claim 9, wherein the query execution plan is indicative of provisioning links between database nodes; or
wherein the query execution plan is indicative of one or more additional execution points or aggregation nodes to be instantiated for execution of the query.

11. The communication network of claim 9, wherein the query execution plan comprises a sequence of database operations.

12. The communication network of claim 9, wherein the DBMS supports a distributed database, and wherein the query execution plan is indicative of instructions for moving data between data storage locations.

13. The communication network of claim 6, wherein the query execution plan is generated by the query response module, the SDT module, or a combination thereof.

14. The communication network of claim 6, wherein the query response module is configured to generate the query execution plan and the SDT module is configured to modify the generated query execution plan.

15. A method for providing database functionality in a communication network, the method comprising:
in response to a database query, determining a query execution plan comprising an indication of a set of Virtual Functions and a set of hardware resource components of the communication network for use in implementing the set of Virtual Functions;
instantiating the set of Virtual Functions and logical connections therebetween using the indicated set of hardware resource components; and
executing the query according to the query execution plan.

16. The method of claim 15, wherein the query execution plan is indicative of instantiating one or more database nodes to process database information.

17. The method of claim 15, wherein the hardware resource components are general-purpose components of the communication network.

18. The method of claim 15, wherein the query execution plan comprises an indication of said logical connections between the set of Virtual Functions.

19. The method of claim 15, wherein the query execution plan is provided in accordance with a query optimization operation, the query execution plan satisfying one or both of a predetermined set of objectives and a predetermined set of constraints, said objectives and constraints pertaining to efficiency of the database query, wherein instantiation of the set of Virtual Functions is based on output of the query optimization operation.

20. The method of claim 19, wherein the query execution plan is indicative of provisioning links between database nodes; or
wherein the query execution plan is indicative of one or more additional execution points or aggregation nodes to be instantiated for execution of the query.

21. The method of claim 19, wherein the query execution plan comprises a sequence of database operations.

22. The method of claim 19, wherein the database is a distributed database, and wherein the query execution plan is indicative of instructions for moving data between data storage locations of the database.

23. The method of claim 15, wherein executing the query comprises operating the set of virtual functions using the communication network.
